(19) United States
(12) Patent Application Publication
(10) Pub. No.: US 2018/0018633 A1
(43) Pub. Date: Jan. 18, 2018

(54) SYSTEMS AND METHODS FOR SUBMITTING JOB APPLICATIONS

(71) Applicants: Amin Khaef, Laguna Beach, CA (US); Ramtin Khaef, Laguna Beach, CA (US)

(72) Inventors: Amin Khaef, Laguna Beach, CA (US); Ramtin Khaef, Laguna Beach, CA (US)

(21) Appl. No.: 15/647,000

(22) Filed: Jul. 11, 2017

Related U.S. Application Data
(60) Provisional application No. 62/361,056, filed on Jul. 12, 2016.

(51) Int. Cl. G06Q 10/10; G06F 17/30

(52) U.S. Cl. CPC G06Q 10/1053; G06F 17/30867

(57) ABSTRACT

Systems and methods for automatically submitting job applications with respect to a job listing service are provided. Upon manual submission of a job application by an applicant responding to a job listing in the job listing service, the system may search for additional job listings similar to the original job listing, and automatically create job applications for the found job listings. Upon submission of a job listing from an employer, the system may search for already-submitted job applications relevant to the job listing, and automatically create job applications responding to the submitted job listing. The system may create an area job application based on a submitted job application which may be automatically viewed by employers instead of creating separate job applications for each found job listing.

### CROSS-REFERENCE TO RELATED APPLICATIONS

The present application claims benefit of U.S. provisional patent application Ser. No. 62/361,056, titled “Systems and Methods For Submitting Job Applications,” filed Jul. 12, 2016, which is incorporated by reference herein in its entirety.

### BACKGROUND

The present disclosure relates generally to software systems and methods for automatically submitting job applications for online job postings on an online job posting platform.

The rise of the internet has significantly changed the job search process. Job listing systems, such as indeed.com and monster.com, are now extensively used by both job candidates and employers. Classified ad systems, such as craigslist.org, are also used. However, the new online job listing systems have increased the job searching burden on job candidates, as the availability of online job systems has increased the number of job listings. Job applicants can spend a great deal of time searching through job listings, and must be able to successfully navigate multiple job listing services, each with a different interface and searching method.

Therefore, there is a need in the field of job listing services for methods and systems that allow job applicants to apply to more online jobs with less effort. It would also be useful if these methods and systems help job applicants apply to online jobs that are relevant to the job applicant.

### SUMMARY

In accordance with the foregoing needs and others, methods, systems and apparatuses, including computer programs encoded on computer storage media, are provided for automatically submitting job applications for online job postings on one or more online job platforms. The automatic submission of the job applications may be based on predefined criteria.

The online job platform includes at least two types of users, job applicants and employers. The online platform also includes a database of job listings created by employers and a database of job applications created by job applicants. The database of job application also includes job applications created by the system, as described herein. When logged into the system, job applicants can search the job listings to find listings that they may be interested in applying for. Job applicants can also view the job applications they have created previously. Employers, when logged into the system can search job applications, view their job listings, and view job applications responding to their job listings. Employers can also view “area” job applications that are relevant to their job listings, as further described herein.

In a typical scenario, an employer posts a job listing on the platform, and in response, interested job applicants create job applications for the job listing. The job applications may be created via one of a number of methods, e.g., an online form, an uploaded resume, etc. Job application and/or resumes may also be automatically imported into the system using any of the methods described in co-pending U.S. application Ser. No. 15/587,723, titled “Systems and Methods for Increasing Users of a Job Listing Service,” which is incorporated by reference in its entirety. Job applications may be stored in a database for later access by both job applicants and employers. When a new job application is created, employers may be notified of the existence of the new job application in the system, e.g., via email or a system notification.

After a job application is created, either in response to a job posting or by automatic importation, the system may then search for other jobs that may be of interest to the job applicant. The system may use a number of search criteria to find additional job listings. These criteria may include job category, job title, job location, distance from the original job, distance from the job applicant's residence, job posting date, and other criteria.

Once the additional job listings have been found, the system may automatically create job applications responsive to the additional job listings on the job applicant's behalf. This may be done with approval from the job applicant, or the additional job applications may be created without any further input from the job applicant.

Additionally or alternatively, after a job application is created by a job applicant or automatically imported, a special type of job application, called herein an “area” job application, may be created in the database. This type of job application comprises information about the job applicant, a location, and a job category, among other possible fields. Of note, this type of job application does not include the specific job listing being responded to. When an employer views job applications responsive to their job listings, the system displays “area” job applications found via a search using criteria based on the job listing in addition to non-“area” job applications specifically responsive to the employer's job listings.

The system may also check newly-posted job listings to see if any job applicants have applied for similar jobs. If so, the system may automatically create job applications on the job applicants' behalf to the newly-posted job listing. This check may be performed on a periodic basis, e.g., every hour, once a day, etc., or the system may check each job listing as it is posted to determine job applicants that may be interested in applying for the job. This search may be based on information about the newly-posted job listing, e.g., job category and job location, or it may be based on the same criteria used in the initial search. If the system creates “area” job applications, this check and related search may not be performed.

The job applicant and employer users of the system each have a user account or profile with various settings. In particular, job applicant accounts and/or profiles include a setting that indicates that the job applicant wants the system to perform the job searches and/or create “area” job applications as described herein. In an alternative embodiment, job applicant accounts and/or profiles may include a separate setting for each search described herein for more granular control of the operation of the system. Employer accounts and/or profiles may also include settings allowing employers control over whether the searches described herein are performed with respect to the employers' job listings.

The system may include one or more servers, and any number of client devices. The database storing the extracted and imported information may be standalone, or may be located in one of the servers. The database may be a Customer Relationship Management (CRM) system or a user table or collection in a relational or non-relational database. The database or CRM system may be part of a larger job listing service where users, including employers and job candidates, can set up accounts, create job postings, apply for jobs, etc.

One embodiment is directed to a computer-implemented method for creating a job application on a job listing service, comprising: receiving a first job application from a first user of the service, the first job application responding to a first job listing listed on the service, wherein the first job listing comprises a position type; finding a second job listing on the job listing service based on the position type of the first job listing; and automatically creating a second job application for the first user responding to the second job listing.

Implementations of this embodiment may include one or more of the following: The second job listing may be found based on additional criteria. The additional criteria may comprise a maximum distance between a location of the first job listing and a location of the second job listing or a maximum distance between a location of the first user and a location of the second job listing. The additional criteria may comprise a maximum age of the second job listing. The additional criteria may comprise a sponsorship status of the second job listing. The position type of the first job listing may be different from the position type of the second job listing. The method may further comprise the step of marking the first job application as a primary job application. The method may further comprise the step of marking the second job application as a secondary job application.

Another embodiment is directed to a computer-implemented method for creating a job application on a job listing service, comprising: receiving a job listing from a first user of the service, wherein the job listing comprises a position type; finding a first job application on the job listing service based on the position type of the job listing, wherein the first job application is from a second user of the service; and automatically creating a second job application for the second user responding to the job listing.

Implementations of this embodiment may include one or more of the following: The first job application may be found based on additional criteria. The additional criteria may comprise a maximum distance between a location of the first job application and a location of the job listing or a maximum distance between a location of the second user and a location of the job listing. The additional criteria may comprise a maximum age of the first job application. The additional criteria may comprise a sponsorship status of the job listing.

Another embodiment is directed to a computer-implemented method for creating a job application on a job listing service, comprising: receiving a first job application from a first user of the service, the first job application responding to a first job listing listed on the service, wherein the first job listing comprises a position type; creating an area job application based on the first job application, wherein the area job application comprises a position type; receiving a second job listing from a second user of the service; searching a database of area job applications based on the second job listing and finding the area job application; and showing information regarding the area job application to the second user of the service.

Implementations of this embodiment may include one or more of the following: The area job application may be found based on additional criteria. The additional criteria may comprise a maximum distance between a location of the area job application and a location of the second job listing. The additional criteria may comprise a maximum age of the first job application. The additional criteria may comprise a sponsorship status of the job listing. The additional criteria may comprise an excluded employer. The position type of the area job application may be different from the position type of the first job listing. The position type of the area job application may be similar to the position type of the first job listing. The area job application may comprise more than one position type.

### BRIEF DESCRIPTION OF THE DRAWINGS

FIG. 1 illustrates an embodiment of a system according to the principles of the present disclosure.

FIG. 2 illustrates an embodiment of a method for automatically submitting additional job applications based on a newly submitted job application according to the principles of the present disclosure.

FIG. 3 illustrates an embodiment of a method for automatically submitting job applications based on a newly submitted job listing according to the principles of the present disclosure.

FIG. 4 illustrates an embodiment of a method for automatically submitting job applications according to the principles of the present disclosure.

FIG. 5 illustrates an embodiment of a method for automatically submitting job applications according to the principles of the present disclosure.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

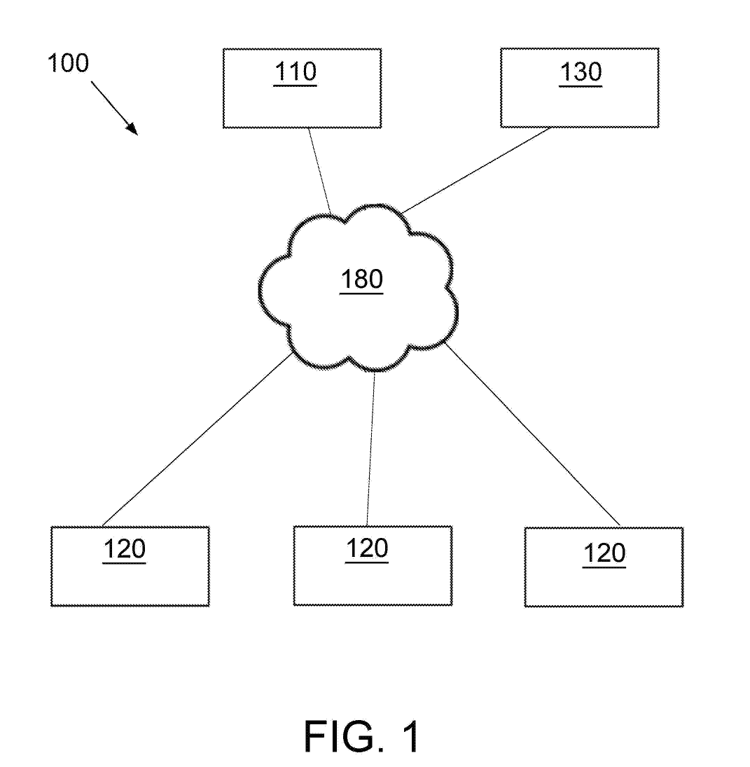

FIG. 1 illustrates one embodiment of a system 100 of the present invention. System 100 may include server 110, database 130, and one or more client devices 120. Server 110, database 130, and client devices 120 communicate through network 180, e.g., the internet, a cloud network, a LAN, a WAN, etc. Client devices 120 can be any type of device capable of communicating with server 110 through network 180, e.g., desktop computers, laptop computers, notebook computers, tablet devices, cellular phones, etc. Server 110 may comprise any device capable of performing one or more of the methods described herein, e.g., a desktop or laptop computer, a server, etc. While server 110 is illustrated as a single device, the functionality of server 110 may be distributed across more than one device. For example, the system 100 may comprise a web server for presenting interfaces and information to client devices 120, an email server for sending emails, etc.

Unless otherwise specified, any step of any of the methods disclosed herein may be performed on the server 110 or a client device 120. Both a traditional client-server architecture, where the majority of the processing is performed on the server, and a more client-centered approach, where the majority of the processing is performed on a client, are within the scope of the present disclosure.

The functionality of the computer application(s) (hereinafter “App”) implementing the steps of the methods disclosed herein can be distributed between the servers and the clients in various ways, as will be described in more detail below. While the application(s) may be referred to as a single “App,” a specific implementation may require several different computer processes, with one or more separate processes running on the server(s), and one or more separate processes running on the clients. The clients may run the client portion of the App as an in-browser component, a stand-alone or installed computer application, a mobile application, a downloadable app, etc. The client portion of the App may also be run via a scripting language such as Javascript. The server may run the server portion of the App as an in-browser component, a stand-alone or installed computer application, a mobile application, a downloadable app, via a scripting language such as Javascript, etc. Note that as used herein, “App” refers to the computer application(s) running on the server(s) and/or client(s), while “application” refers to a job application.

Database 130 can be any type of device capable of storing data and communicating through network 180, e.g., desktop computers, laptop computers, notebook computers, tablet devices, cellular phones, etc. Database 130 stores information regarding the job listing service, e.g., user (employers, job applicants, job candidates, etc.) accounts, entity profiles and/or accounts, job listings, job applications, “area” job applications, resumes, mappings between job applicants and job listings (indicating that the applicant has applied to the job listing), etc. An “entity” as used herein refers to a user or a potential user of the system, e.g., employers, job applicants, job candidates, etc., with or without an account. An “account” as used herein refers to the information stored relating to a user who is able to sign into the system, e.g., using a user name and password. A “profile” as used herein refers to the information stored relating to an entity, who may not be able to sign in to the system. In general, a profile will not include a user name and password or other log in information.

Job applications comprise two types—“normal” job applications and “area” job applications. “Normal” job applications include the job listing being responded to, in additional to traditional fields such as applicant name, applicant location, applicant work experience, applicant education experience, etc. “Area” job applications do not include the specific job listing being responded to. Instead they include other fields that indicate the type of job listings the job applicant associated with the “area” job application is interested in, e.g., location, job category, etc.

“Normal” job applications (hereinafter referred to as “job applications”) may be classified as either primary applications or secondary applications. Primary job applications are applications manually created by a job applicant or job application and resumes imported into the system. Secondary job applications are applications automatically created by the system on behalf of the job applicant. This distinction allows the system to avoid an infinite loop when automatically creating job applications.

Database 130 may be a separate device as shown in FIG. 1, or, in an alternative embodiment, may be part of and/or incorporated into server 110.

The below methods make reference to a location of either a job listing or a job applicant. In either case, the location may be stored as traditional address, any portion of a traditional address (e.g., a zip code), a geohash, a latitude/longitude coordinate pair, or any other way of referencing a location.

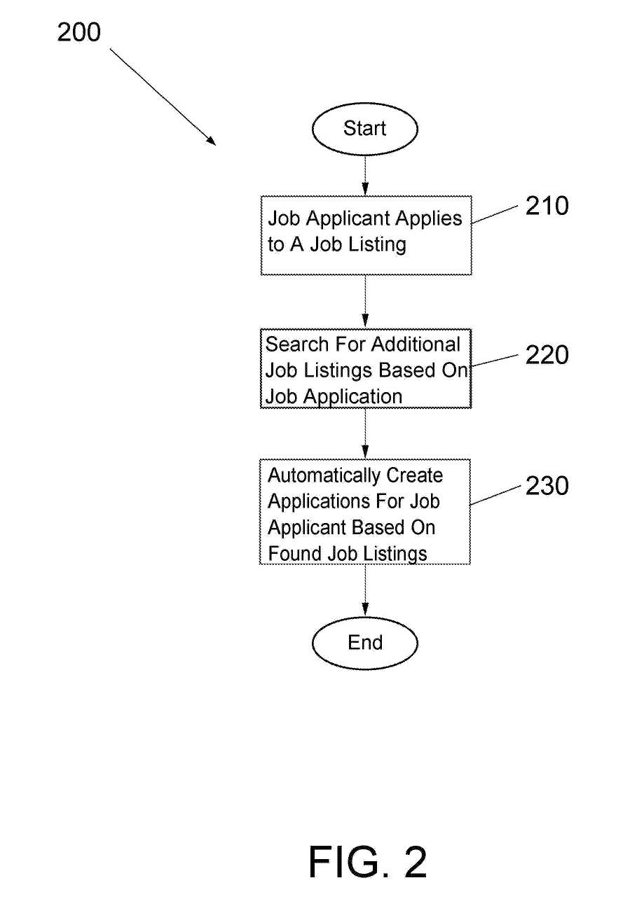

FIG. 2 illustrates a method 200 according to one embodiment. In step 210, a job applicant applies to job listed on the system. The job listing has a position type, or job category, e.g., line cook, barber, telemarketer, etc. The job listing also may include a location and job title. This job listing will be referred to as the ‘original’ job listing for the remainder of the description of this method. The applicant may apply to the job using various methods, e.g., an online form, uploading a resume, etc. Alternative, a job application and/or resume may be automatically imported into the system, using the techniques described in co-pending U.S. application Ser. No. 15/587,723.

In step 220, the system searches for additional job listings for the job application. In one embodiment, this search is only performed if the job applicant has enabled the appropriate option (e.g., an “allow automatic job applications” option) in the job applicant's user account or profile. Also, the search is only performed if the job application is a primary application, to prevent an endless loop of additional searches being performed for each automatically-created application.

The search is performed based on criteria, either predefined or defined at the time of the search. The criteria may be based wholly or partially on options in user profiles or accounts, e.g., the job applicant's account or profile, the employer accounts or profiles associated with the job listings, etc. Such options may include: maximum distance to search from the original job listing, maximum distance to search from the job applicant's residence, maximum job age (e.g., the elapsed time from the job posting date), pay rate, full-time/part-time status, etc. The criteria may additionally be based on system settings, which may include the above-listed user options.

For example, if a job applicant applies for a job as a barber at a particular address, the system may search for additional job listings that have the ‘barber’ job category that are within a the distance specified in the user account or profile from the original job listing. The system may further limit the job listings returned based on the job posting date, e.g., limit the jobs returned to jobs posted within the last month.

The system may also prompt the job applicant if he or she wants the query to be expanded to include broader or similar job categories. For example, if the original job application was for a job with the ‘barber’ job category, the system may query the applicant if the query should be expanded to include the ‘personal care’ category (a broader category) or the ‘hair stylist’ category (a similar category).

The system may also prevent certain job listings from being found by the search, e.g., employers may be able to set an option in their accounts or profiles to hide their job listings from the automatic search. This may be defined on an employer level (e.g., all job listings of the employer are hidden), or the employer may be able to define this separately for each job listing.

As another example, a job applicant user may wish to prevent certain employers' job listings (e.g., the user's current employer) from being found in the search. The system may prompt the job applicant user for any employers to exclude from the search.

In step 230, the system copies the job application and sends a copy to the employer associated with each of the job listings found in the previous step. Alternatively, the system may create a new job application in the database for each found job listing. The system may prompt the job applicant to provide permission for the creation of the job applications. Alternatively, the system may create the job applications automatically, without the need for further input from the job applicant. This behavior may be controlled by a user-defined option. Automatic job applications are not created for job listings to which the job application has already applied.

The job applications or copies created in this step are flagged as secondary, or automatically generated, job applications. As described above with respect to step 220, the system will only search for additional jobs if the submitted job application is not flagged as a secondary job application. This is to prevent the system from successively creating job applications to job listings further and further away from the original job listing in a loop.

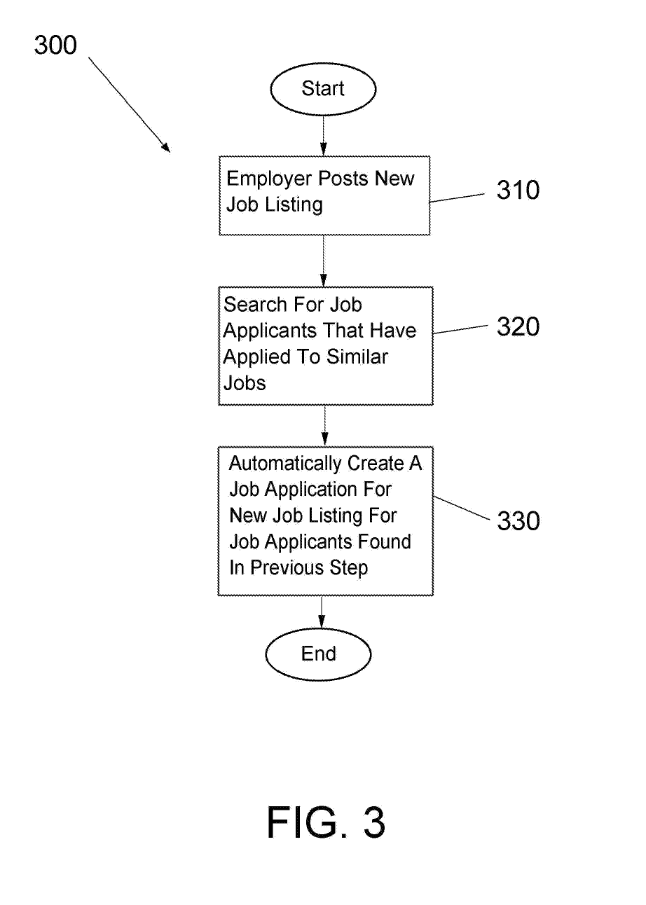

FIG. 3 illustrates a method 300 according to another embodiment. In step 310, an employer posts a new job listing to the job listing service.

In step 320, the system searches for job applications in the database that are directed to jobs similar to the new job listing. The system can perform the search using the same or similar criteria listed in step 220 of method 200 e.g., job category, job title, job location, maximum distance from the original job listing, maximum distance from the job applicant's residence, maximum application age (instead of maximum job listing age), pay rate, full-time/part-time status, excluded employers, etc. For example, if a new job listing is created in the ‘barber’ job category, the system may search job applications that have been submitted in the ‘barber’ job category and within a certain distance from the job location. The job applicant's location may be used instead of the job location. Also, the search may be time-limited, i.e., may only search for job applications that were submitted within a certain time period, e.g., two weeks.

In addition, only job applications from job applicants that have previously indicated in their user accounts or profiles that they want to have the system include their applications in this type of search will be included in the search results. This may be defined on an account/profile level (e.g., all applications of the user are hidden), or the user may be able to define this separately for each application.

In step 330, the system copies each job application identified in step 320 and sends a copy of each job application to the employer associated with the new job posting. Alternatively, the system may create new job applications in the database for each found job listing. The system may prompt the job applicants, e.g., via email or other notification, to provide permission for the job applications to be created. Alternatively, the system may create the job applications automatically, without the need for further input from the job applicants. This behavior may be controlled by a user-defined option in the job applicants' accounts or profiles.

The job applications or copies created in this step are flagged as secondary, or automatically generated, job applications.

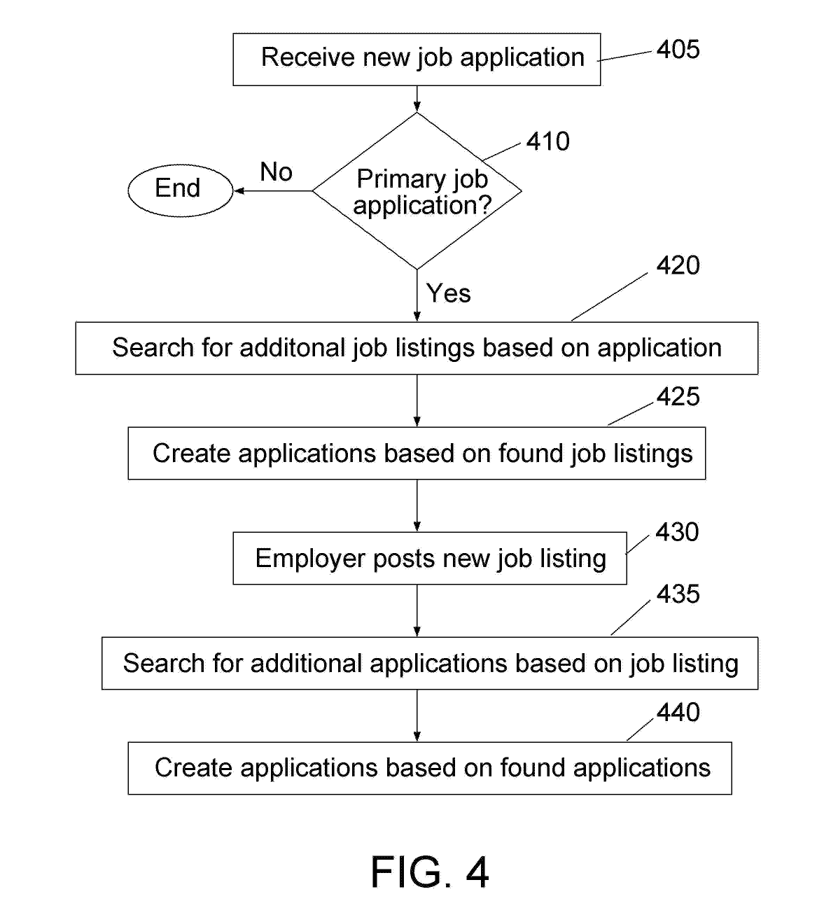

FIG. 4 illustrates a method 400 according to one embodiment. In step 405, a job application is received by the system, because a job applicant applied to job listed on the system, a job application or resume was imported into the system, or because a job application was automatically generated, using the techniques described herein.

The job listing associated with the received job application has a position type, or job category, e.g., line cook, barber, telemarketer, etc. The job listing also may include a location and job title. This job listing will be referred to as the ‘original’ job listing for the remainder of the description of this method.

If step 410, the system determines if the job application is a primary job application, i.e, a job application created by a job applicant user or imported into the system. If so, the method continues to step 420. If not, the method ends.

Is step 420, a search for additional job applications is performed. The search is performed based on criteria, either predefined or defined at the time of the search. The criteria may be based wholly or partially on options in user accounts or profiles, e.g., the job applicant's account or profile, the employer accounts or profiles associated with the job listings, etc. Such options may include: maximum distance to search from the original job listing, maximum distance to search from the job applicant's residence, maximum job age (e.g., the elapsed time from the job posting date), pay rate, full-time/part-time status, etc. The criteria may additionally be based on system settings, which may include the above-listed user options.

For example, if a job applicant applies for a job as a barber at a particular address, the system may search for additional job listings that have the ‘barber’ job category that are within a the distance specified in the user account or profile from the original job listing. The system may further limit the job listings returned based on the job posting date, e.g., limit the jobs returned to jobs posted within the last month.

The system may also prompt the job applicant if he or she wants the query to be expanded to include broader or similar job categories. For example, if the original job application was for a job with the ‘barber’ job category, the system may query the applicant if the query should be expanded to include the ‘personal care’ category (a broader category) or the ‘hair stylist’ category (a similar category).

The system may also prevent certain job listings from being found by the search, e.g., employers may be able to set an option in their accounts or profiles to hide their job listings from the automatic search. This may be defined on an employer level (e.g., all job listings of the employer are hidden), or the employer may be able to define this separately for each job listing.

As another example, a job applicant user may wish to prevent certain employers' job listings (e.g., the user's current employer) from being found in the search. The system may prompt the job applicant user for any employers to exclude from the search.

In step 425, for each job listing found in the previous step, the system creates a new job application in the database. The system may prompt the job applicant to provide permission for the creation of the new job applications. Alternatively, the system may create the job applications automatically, without the need for further input from the job applicant. This behavior may be controlled by a user-defined option. Automatic job applications are not created for job listings to which the job application has already applied. Each new job application (or copy) is flagged as a secondary, or automatically generated, job application.

In step 430, an employer posts a new job listing to the job listing service.

In step 435, the system searches for job applications in the system directed to jobs similar to the new job listing. The system can perform the search using the same or similar criteria listed in step 420, e.g., job category, job title, job location, maximum distance from the original job listing, maximum distance from the job applicant's residence, maximum application age (instead of maximum job listing age), pay rate, full-time/part-time status, excluded employers, etc. For example, if a new job listing is created in the ‘barber’ job category, the system may search job applications that have been submitted in the ‘barber’ job category and within a certain distance from the job location. The job applicant's location may be used instead of the job location. Also, the search may be time-limited, i.e., may only search for job applications that were submitted within a certain time period, e.g., two weeks.

In addition, only job applications from job applicants that have previously indicated in their user accounts or profiles that they want to have the system include their applications in this type of search will be included in the search results. This may be defined on an account/profile level (e.g., all applications of the user are hidden), or the user may be able to define this separately for each application.

The search described in this step may be performed each time an employer submits a new job listing, or on a periodic basis, e.g., hourly, daily, etc.

In step 440, for each job application found in the previous step, the system creates a new job application (or a copy of the original job application). The system may prompt the job applicants, e.g., via email or other notification, to provide permission for the job applications to be created. Alternatively, the system may create the job applications automatically, without the need for further input from the job applicants. This behavior may be controlled by a user-defined option in the job applicants' accounts or profiles. The job applications or copies sent in this step are flagged as secondary, or automatically generated, job applications.

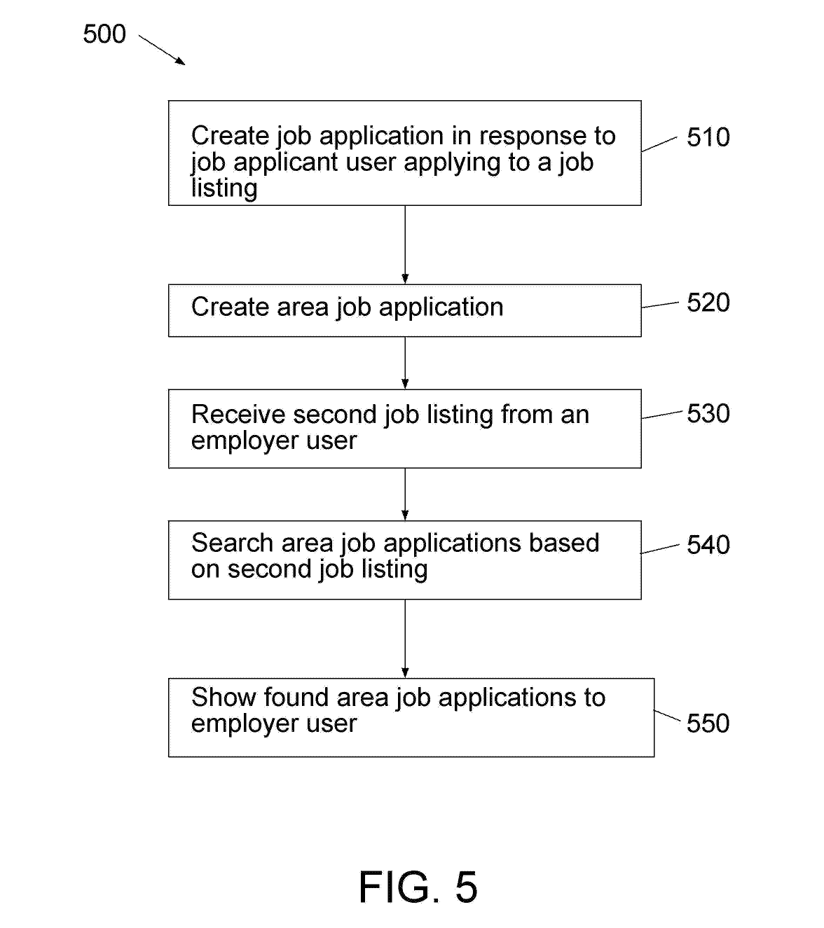

FIG. 5 illustrates a method 500 according to one embodiment. In step 510, a job applicant applies to job listed on the system. The job listing has a position type, or job category, e.g., line cook, barber, telemarketer, etc. The job listing also may include a location and job title. The applicant may apply to the job using various methods, e.g., an online form, uploading a resume, etc. In response, the system creates a new job application for the job applicant in the database. Alternatively, a job application may be imported into the system using any of the techniques described in co-pending U.S. application Ser. No. 15/587,723. This job application will be referred to as the ‘original’ job application, and this job listing will be referred to as the ‘original’ job listing, for the remainder of the description of this method.

In step 520, the system creates an area job application in the database for the applicant based on the original job application. The area job application includes information about the job applicant (e.g., applicant name, ID, or other identifying information), a job category, and a location. The area job application may be automatically created by the system, or the system may prompt the job applicant to provide permission for the creation of the area job application. This behavior may be controlled by a user-defined option.

The job category of the area job application may be set to the job category of the original job application. The system may also set the job category of the area job application to a broader, narrower, or similar job category, depending on input from the job applicant. For example, if the job category of the original job application is ‘cashier,’ the system may prompt the job applicant if he or she wants to broaden the job category to, e.g., ‘host.’ As another example, if the job category of the original job application is ‘host,’ the system may prompt the job applicant if he or she wants to narrow the job category to, e.g., ‘cashier.’ As a further example, if the job category of the original job application is ‘barber,’ the system may prompt the job applicant if he or she wants to add the similar job category of ‘hair stylist.’

Area job applications may also include multiple job categories, and these may include the job category of the original job application and additional job categories, e.g., the broader and narrower categories described above. The job applicant may be prompted to add additional job categories to the area job application.

The location of the area job application may be set to the location of the original job listing, the location of the applicant, or another location, based on input from the job applicant or a setting in the job applicant's account or profile. For example, the system may prompt the job applicant prior to creation of the area job application if the job applicant wants the location of the area job application to be the location of the job listing or the job applicant's location.

The area job application may also include a maximum distance from the location to be searched (e.g., in step 540 below).

In step 530, an employer, which may be different from the one associated with the original job listing, logs onto the system. The employer may create a new job listing or may have previously created a job listing.

In step 540, when the logged-in employer views relevant job applicants (e.g., on a “my candidates” page), the system searches the area job applications based on criteria as described above with respect to step 220 of method 200, e.g., job category, job title, job location, maximum distance from the original job listing, maximum distance from the job applicant's residence, maximum application age, pay rate, full-time/part-time status, excluded employers, etc. These criteria may be either predefined or defined at the time of the search. The criteria may be wholly or partially based on options in user accounts or profiles, e.g., the account or profile of the area job applicant, the account or profile of the employer, etc. Alternatively or additionally, the criteria may be wholly or partially defined in the area job application.

For example, if a new job listing is created in the ‘barber’ job category, the system may search area job applications with the ‘barber’ job category and with a defined location within a certain distance from the job location. The maximum distance may be defined in the job applicant's account or profile, or may be defined in the “area” job application. Also, the search may be time-limited, i.e., may only search for “area” job applications that were submitted within a certain time period, e.g., the prior two weeks.

After relevant area job applications are found, in step 550 the found area job applications are shown to the employer. Job applications specifically responding to the employer's job listings are also shown.

In each of the methods described herein, as an alternative to an option or setting in the user account or profile informing the system that the job applicant wants the automatic search and application process to be performed, the option or setting may be part of or associated with individual job applications, including area job applications. In this case, the system will check the option or setting on a per job application basis rather than an option or setting in the job applicant's account or profile. In the case where the job application is imported into the system, the job applicant may not have a user account, so user account options may not be set or checked.

The job applicant can indicate to the system that he or she no longer wishes these searches to be performed on his or her behalf and/or area job application to be searched, e.g., when the job applicant has found a job, by changing the setting(s) in the job applicant's account or profile and/or the setting(s) in the job applicant's applications. Also, if an employer rejects a job application, the employer can indicate that the reason for the rejection is that the job applicant has already found a job, and the system can then automatically change the setting in the job applicant's account or profile, preventing the searches described herein from being performed on the job applicant's behalf. Similarly, if the employer hires a job applicant, the system can be informed of the hire, and the job applicant can be removed from further searches. These automatic changes to the job applicant's account or profile settings may require confirmation from the user, e.g., via an email or a user prompt the next time the user logs into the system. Alternatively, the system may automatically make the change to the job applicant's account or profile, and notify the user of the change, e.g., via email or a user prompt. In the embodiments using area job applications, the area job applications may be removed from the database, or may be marked (e.g., as “inactive”) to prevent them from appearing in search results. Inactive area job applications may be removed from the system after a predefined length of time.

An optional criteria that may be used for any of the methods described herein is the sponsorship status of an employer or a particular job listing. Sponsorship status refers to an extra benefit which is often paid for. In this case, an employer may be required to have sponsorship status before viewing secondary job applications or area job applications created via the methods described herein. In addition, an employer may be required to have sponsorship status before the searches described herein (e.g., method 300, step 440 of method 400) are performed for its job listings. Alternatively, sponsorship may be determined on a job listing basis, with an employer deciding for each job listing whether to sponsor it. As an additional alternative, rather than being excluded from the searches described herein, a non-sponsored employer or job listing may have the searches performed on a time-delayed basis, e.g., a certain amount of time after the sponsored employers or job listings.

The embodiments disclosed herein meet the needs of both employers and job applicants in helping potential employees find jobs. Job applicants can apply to more jobs in less time, and the system can make sure that the jobs that are applied for automatically are relevant to the job applicant. Employers can receive more applications for each job, and will be able to select the best candidate. This system helps ensure that the job searching and employee hiring processes are performed in a more streamlined manner, while creating better matches for both the employer and the job seeker.

Unless specifically stated otherwise, as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

Embodiments of the subject matter and the functional operations described in this specification can be implemented in one or more of the following: digital electronic circuitry; tangibly-embodied computer software or firmware; computer hardware, including the structures disclosed in this specification and their structural equivalents; and combinations thereof. Such embodiments can be implemented as one or more modules of computer program instructions encoded on a tangible non-transitory program carrier for execution by, or to control the operation of, data processing apparatus (i.e., one or more computer programs). Program instructions may be, alternatively or additionally, encoded on an artificially generated propagated signal (e.g., a machine-generated electrical, optical, or electromagnetic signal) that is generated to encode information for transmission to suitable receiver apparatus for execution by a data processing apparatus. And the computer storage medium can be one or more of: a machine-readable storage device, a machine-readable storage substrate, a random or serial access memory device, and combinations thereof.

As used herein, the term “data processing apparatus” comprises all kinds of apparatuses, devices, and machines for processing data, including but not limited to, a programmable processor, a computer, and/or multiple processors or computers. Exemplary apparatuses may include special purpose logic circuitry, such as a field programmable gate array (“FPGA”) and/or an application specific integrated circuit (“ASIC”). In addition to hardware, exemplary apparatuses may comprise code that creates an execution environment for the computer program (e.g., code that constitutes one or more of: processor firmware, a protocol stack, a database management system, an operating system, and a combination thereof).

The term “computer program” may also be referred to or described herein as a “program,” “software,” a “software application,” a “module,” a “software module,” a “script,” or simply as “code.” A computer program may be written in any form of programming language, including compiled or interpreted languages, or declarative or procedural languages, and it can be deployed in any form, including as a standalone program or as a module, component, subroutine, or other unit suitable for use in a computing environment. Such software may correspond to a file in a file system. A program can be stored in a portion of a file that holds other programs or data. For example, a program may include one or more scripts stored in a markup language document; in a single file dedicated to the program in question; or in multiple coordinated files (e.g., files that store one or more modules, sub programs, or portions of code). A computer program can be deployed and/or executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as but not limited to an FPGA and/or an ASIC.

Computers suitable for the execution of the one or more computer programs include, but are not limited to, general purpose microprocessors, special purpose microprocessors, and/or any other kind of central processing unit (“CPU”). Generally, CPU will receive instructions and data from a read only memory (“ROM”) and/or a random access memory (“RAM”). The essential elements of a computer are a CPU for performing or executing instructions and one or more memory devices for storing instructions and data. Generally, a computer will also include, or be operatively coupled to receive data from or transfer data to, or both, one or more mass storage devices for storing data (e.g., magnetic, magneto optical disks, and/or optical disks). However, a computer need not have such devices. Moreover, a computer may be embedded in another device, such as but not limited to, a mobile telephone, a personal digital assistant (“PDA”), a mobile audio or video player, a game console, a Global Positioning System (“GPS”) receiver, or a portable storage device (e.g., a universal serial bus (“USB”) flash drive).

Computer readable media suitable for storing computer program instructions and data include all forms of nonvolatile memory, media and memory devices. For example, computer readable media may include one or more of the following: semiconductor memory devices, such as erasable programmable read-only memory (“EPROM”), electrically erasable programmable read-only memory (“EEPROM”) and/or and flash memory devices; magnetic disks, such as internal hard disks or removable disks; magneto optical disks; and/or CD-ROM and DVD-ROM disks. The processor and the memory can be supplemented by, or incorporated in, special purpose logic circuitry.

To provide for interaction with a user, embodiments may be implemented on a computer having any type of display device for displaying information to a user. Exemplary display devices include, but are not limited to one or more of: projectors, cathode ray tube (“CRT”) monitors, liquid crystal displays (“LCD”), light-emitting diode (“LED”) monitors and/or organic light-emitting diode (“OLED”) monitors. The computer may further comprise one or more input devices by which the user can provide input to the computer. Input devices may comprise one or more of: keyboards, a pointing device (e.g., a mouse or a trackball). Input from the user can be received in any form, including acoustic, speech, or tactile input. Moreover, feedback may be provided to the user via any form of sensory feedback (e.g., visual feedback, auditory feedback, or tactile feedback). A computer can interact with a user by sending documents to and receiving documents from a device that is used by the user (e.g., by sending web pages to a web browser on a user's client device in response to requests received from the web browser).

Embodiments of the subject matter described in this specification can be implemented in a computing system that includes one or more of the following components: a backend component (e.g., a data server); a middleware component (e.g., an application server); a front end component (e.g., a client computer having a graphical user interface (“GUI”) and/or a web browser through which a user can interact with an implementation of the subject matter described in this specification); and/or combinations thereof. The components of the system can be interconnected by any form or medium of digital data communication, such as but not limited to, a communication network. Non-limiting examples of communication networks include a local area network (“LAN”) and a wide area network (“WAN”), e.g., the Internet.

The computing system may include clients and/or servers. The client and server may be remote from each other and interact through a communication network. The relationship of client and server arises by virtue of computer programs running on the respective computers and having a client-server relationship to each other.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. A computer-implemented method for creating a job application on a job listing service, comprising:
a. receiving a first job application from a first user of the service, the first job application responding to a first job listing listed on the service, wherein the first job listing comprises a position type;
b. finding a second job listing on the job listing service based on the position type of the first job listing; and
c. automatically creating a second job application for the first user responding to the second job listing.

2. The computer-implemented method for creating a job application of claim 1, wherein the second job listing is found based on additional criteria.

3. The computer-implemented method for creating a job application of claim 2, wherein the additional criteria comprises a maximum distance between a location of the first job listing and a location of the second job listing or a maximum distance between a location of the first user and a location of the second job listing.

4. The computer-implemented method for creating a job application of claim 2, wherein the additional criteria comprises a maximum age of the second job listing.

5. The computer-implemented method for creating a job application of claim 2, wherein the additional criteria comprises a sponsorship status of the second job listing.

6. The computer-implemented method for creating a job application of claim 1, wherein the position type of the first job listing is different from the position type of the second job listing.

7. The computer-implemented method for creating a job application of claim 1, further comprising the step of marking the first job application as a primary job application.

8. The computer-implemented method for creating a job application of claim 7, further comprising the step of marking the second job application as a secondary job application.

9. A computer-implemented method for creating a job application on a job listing service, comprising:
a. receiving a job listing from a first user of the service, wherein the job listing comprises a position type;
b. finding a first job application on the job listing service based on the position type of the job listing, wherein the first job application is from a second user of the service; and
c. automatically creating a second job application for the second user responding to the job listing.

10. The computer-implemented method for creating a job application of claim 9, wherein the first job application is found based on additional criteria.

11. The computer-implemented method for creating a job application of claim 10, wherein the additional criteria comprises a maximum distance between a location of the first job application and a location of the job listing or a maximum distance between a location of the second user and a location of the job listing.

12. The computer-implemented method for creating a job application of claim 10, wherein the additional criteria comprises a maximum age of the first job application.

13. The computer-implemented method for creating a job application of claim 10, wherein the additional criteria comprises a sponsorship status of the job listing.

14. A computer-implemented method for creating a job application on a job listing service, comprising:
a. receiving a first job application from a first user of the service, the first job application responding to a first job listing listed on the service, wherein the first job listing comprises a position type;
b. creating an area job application based on the first job application, wherein the area job application comprises a position type;
c. receiving a second job listing from a second user of the service;
d. searching a database of area job applications based on the second job listing and finding the area job application; and
e. showing information regarding the area job application to the second user of the service.

15. The computer-implemented method for creating a job application on a job listing service of claim 14, wherein the area job application is found based on additional criteria.

16. The computer-implemented method for creating a job application on a job listing service of claim 15, wherein the additional criteria comprises a maximum distance between a location of the area job application and a location of the second job listing.

17. The computer-implemented method for creating a job application on a job listing service of claim 15, wherein the additional criteria comprises a maximum age of the first job application.

18. The computer-implemented method for creating a job application on a job listing service of claim 15, wherein the additional criteria comprises a sponsorship status of the job listing.

19. The computer-implemented method for creating a job application on a job listing service of claim 15, wherein the additional criteria comprises an excluded employer.

20. The computer-implemented method for creating a job application on a job listing service of claim 14, wherein the position type of the area job application is different from the position type of the first job listing.

21. The computer-implemented method for creating a job application on a job listing service of claim 20, wherein the position type of the area job application is similar to the position type of the first job listing.

22. The computer-implemented method for creating a job application on a job listing service of claim 14, wherein the area job application comprises more than one position type.
